(19) United States
(12) Patent Application Publication
(10) Pub. No.: US 2023/0264309 A1
(43) Pub. Date: Aug. 24, 2023

(54) REPLACING APPARATUS AND REPLACING METHOD

(71) Applicant: Tokyo Electron Limited, Tokyo (JP)

(72) Inventors: Yasutaka MIZOMOTO, Kikuchi-gun, Kumamoto (JP); Susumu HAYAKAWA, Kikuchi-gun, Kumamoto (JP)

(21) Appl. No.: 17/997,558

(22) PCT Filed: Apr. 7, 2021
(86) PCT No.: PCT/JP2021/014827

§ 371 Date: Oct. 31, 2022

(30) Foreign Application Priority Data
May 1, 2020 (JP) 2020-081377

(51) Int. Cl. B23Q 3/157; B24B 45/00; B23Q 3/155

(52) U.S. Cl. CPC B23Q 3/15713; B24B 45/003; B23Q 3/1554

(57) ABSTRACT

A replacing apparatus is configured to replace a processing tool in a processing apparatus. The processing apparatus includes a holder configured to hold a processing target object, a processing mechanism to which the processing tool configured to process the processing target object held by the holder is installed in a replaceable manner, and an exterior cover accommodating therein the holder and the processing mechanism. The replacing apparatus includes a replacing mechanism, a moving mechanism, a traveling table and a traveling mechanism. The replacing mechanism installs the processing tool to the processing mechanism, or separates the processing tool from the processing mechanism. The moving mechanism is configured to move the replacing mechanism from an outside of the exterior cover to an inside thereof through an entrance opening of the exterior cover. The traveling table supports the moving mechanism. The traveling mechanism is configured to allow the traveling table to travel.

### TECHNICAL FIELD

The various aspects and embodiments described herein pertain generally to a replacing apparatus and a replacing method.

### BACKGROUND

A grinding device described in Patent Document 1 includes a spindle, a wheel mount disposed at a lower end of the spindle, and a grinding wheel detachably mounted to a bottom surface of the wheel mount. The grinding wheel includes an annular wheel base and a plurality of grinding whetstones annularly arranged on a bottom surface of the wheel base. An operator mounts the wheel base to the bottom surface of the wheel mount by a fastening bolt.

### PRIOR ART DOCUMENT

Patent Document 1: International Publication No. 2019-177444

### DISCLOSURE OF THE INVENTION

### Problems to be Solved by the Invention

Exemplary embodiments provide a technique capable of preventing an operator from getting dirty when replacing a processing tool.

### Means for Solving the Problems

In an exemplary embodiment, a replacing apparatus is configured to replace a processing tool in a processing apparatus. The processing apparatus includes a holder configured to hold a processing target object, a processing mechanism to which the processing tool configured to process the processing target object held by the holder is installed in a replaceable manner, and an exterior cover accommodating therein the holder and the processing mechanism. The replacing apparatus includes a replacing mechanism, a moving mechanism, a traveling table and a traveling mechanism. The replacing mechanism is configured to install the processing tool to the processing mechanism, or separate the processing tool from the processing mechanism. The moving mechanism is configured to move the replacing mechanism from an outside of the exterior cover to an inside thereof through an entrance opening of the exterior cover. The traveling table supports the moving mechanism. The traveling mechanism is configured to allow the traveling table to travel.

### Effect of the Invention

According to the exemplary embodiment, it is possible to suppress the operator from getting dirty when replacing the processing tool.

### BRIEF DESCRIPTION OF THE DRAWINGS

FIG. 1 is a plan view illustrating an example of a layout of a factory.

FIG. 2 is a plan view illustrating another example of the layout of the factory.

FIG. 3 is a plan view illustrating a grinding system.

FIG. 4 is a cross sectional view illustrating a processing mechanism of a grinding apparatus according to an exemplary embodiment.

FIG. 5 is a cross sectional view illustrating the grinding apparatus and a replacing apparatus according to the exemplary embodiment.

FIG. 6 is an enlarged cross section view illustrating a part of FIG. 5.

FIG. 7 is a functional block diagram illustrating constituent components of controllers of the grinding apparatus and the replacing apparatus according to the exemplary embodiment.

FIG. 8 is a cross sectional view illustrating the grinding apparatus and the replacing apparatus according to a first modification example.

FIG. 9 is a cross sectional view illustrating the grinding apparatus and the replacing apparatus according to a second modification example.

FIG. 10 is a cross sectional view illustrating the grinding apparatus and the replacing apparatus according to a third modification example.

FIG. 11 is a plan view illustrating an example of a replacing apparatus equipped with a storage.

FIG. 12 is a cross sectional view illustrating a first modification example of a fastener.

FIG. 13 is a cross sectional view illustrating a second modification example of the fastener.

FIG. 14 is a cross sectional view illustrating an example of a first rotating mechanism.

FIG. 15 is a cross sectional view illustrating an example of a gas supply mechanism.

FIG. 16 is a cross sectional view illustrating another example of a gas supply mechanism.

FIG. 17 is a cross sectional view illustrating an example of a second rotating mechanism.

### DETAILED DESCRIPTION

Hereinafter, an exemplary embodiment of the present disclosure will be described with reference to the accompanying drawings. In the various drawings, same or corresponding parts will be assigned same reference numerals, and redundant description may be omitted. In the present specification, the X-axis direction, the Y-axis direction, and the Z-axis direction are orthogonal to each other. The X-axis and Y-axis directions are horizontal directions, and the Z-axis direction is a vertical direction.

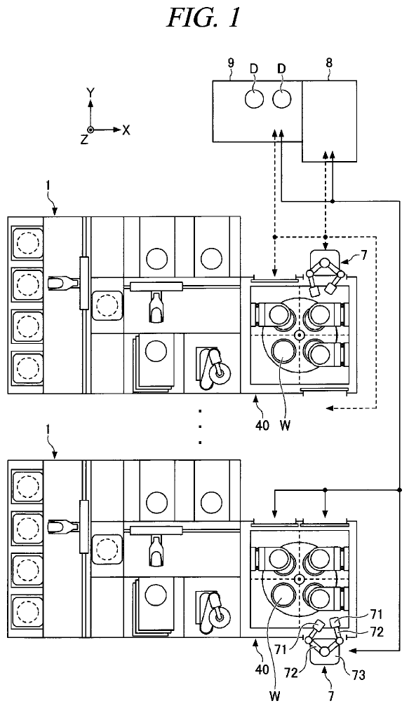

As shown in FIG. 1, a grinding system 1 configured to grind a substrate W, a replacing apparatus 7 configured to replace a grinding tool D mounted in the grinding system 1, a storage 8 for storing therein the replacing apparatus 7, and a storage 9 for storing therein the grinding tool D are installed in a room of a factory, for example. The factory may be, for example, a semiconductor factory, and the room may be, for example, a clean room.

The substrate W includes a semiconductor substrate such as a silicon wafer or a compound semiconductor wafer, or a glass substrate. The substrate W may further include a device layer formed on a surface of the semiconductor substrate or the glass substrate. The device layer includes an electronic circuit. Further, the substrate W may be a combined substrate composed of a plurality of substrates bonded to each other.

As shown in FIG. 1, a plurality of grinding systems 1 may be disposed in the factory room, or only one may be disposed therein. The grinding system 1 is configured to grind the substrate W with the grinding tool D. If the grinding tool D is worn out, it is replaced by the replacing apparatus 7. Since the replacing apparatus 7, instead of a person, replaces the grinding tool D, it is possible to suppress the person from getting dirty. Replacing the grinding tool D includes separating a used grinding tool D and installing an unused grinding tool D.

The storage 9 stores therein the grinding tools D. The used grinding tool D and the unused grinding tool D are stored in the same storage 9 in the present exemplary embodiment. However, they may be stored in different storages 9. The storage 9 is provided outside the grinding system 1. Therefore, the grinding system 1 can be scaled down. Since the storage 9 is provided outside the grinding system 1, a self-propelled robot is used as the replacing apparatus 7, unlike a case where the storage 9 is provided inside the grinding system 1.

The replacing apparatus 7 stands by in the storage 8 until it receives a replacement instruction for the grinding tool D. If the replacement instruction is received, the replacing apparatus 7 travels to the grinding system 1, for example, and separates the used grinding tool D from the grinding system 1. Then, the replacing apparatus 7 travels to the storage 9 while holding the separated used grinding tool D, and places the used grinding tool D in the storage 9. Thereafter, the replacing apparatus 7 acquires the unused grinding tool D from the storage 9, travels to the grinding system 1 while holding the acquired unused grinding tool D, and installs the unused grinding tool D to the grinding system 1. Finally, the replacing apparatus 7 returns to the storage 8 and stands by.

Alternatively, if the replacing apparatus 7 receives the replacement instruction, it first travels to the storage 9, acquires the unused grinding tool D from the storage 9, and travels to the grinding system 1 while holding the acquired unused grinding tool D. Then, the replacing apparatus 7 separates the used grinding tool D from the grinding system 1. Next, the replacing apparatus 7 installs the unused grinding tool D to the grinding system 1. Thereafter, the replacing apparatus 7 travels to the storage 9 while holding the separated used grinding tool D, and places the used grinding tool D in the storage 9. Finally, the replacing apparatus 7 returns to the storage 8 and stands by.

The storage 9 is shared by the plurality of grinding systems 1. As compared to a case where the storage 9 is provided for each of the grinding systems 1 individually, the number of the storage 9 that needs to be installed can be reduced.

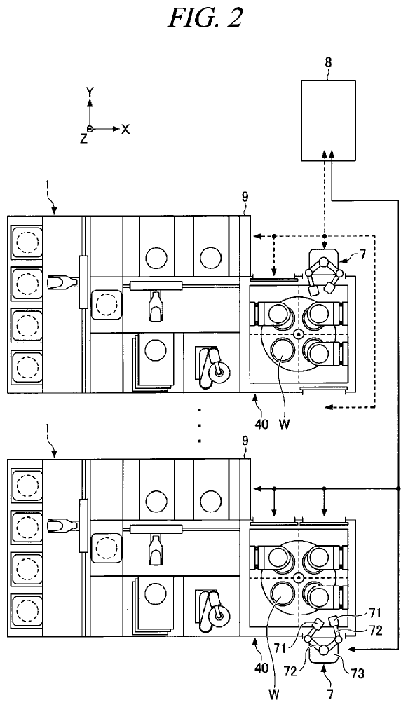

In addition, as illustrated in FIG. 2, the storage 9 may be provided for each of the grinding systems 1 individually. In this case, as compared to the case where the storage 9 is shared by the plurality of grinding systems 1, each storage 9 can be disposed closer to the corresponding grinding system 1.

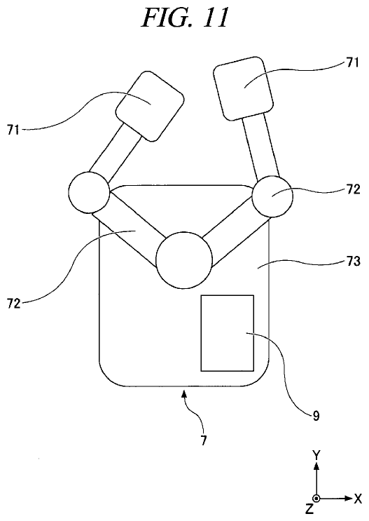

In addition, although the storage 9 shown in FIG. 1 and FIG. 2 is provided separately from the replacing apparatus 7, the replacing apparatus 7 itself may be equipped with the storage 9, as shown in FIG. 11. The storage 9 of the replacing apparatus 7 is moved along with a traveling table 73 of the replacing apparatus 7. In this case, a travel distance of the replacing apparatus 7 can be shortened. The storage 9 of the replacing apparatus 7 temporarily stores therein the grinding tool D that is transferred between the storage 9 (see FIG. 1 or FIG. 2) fixed at the outside of the replacing apparatus 7 and a processing mechanism 43 of the grinding system 1.

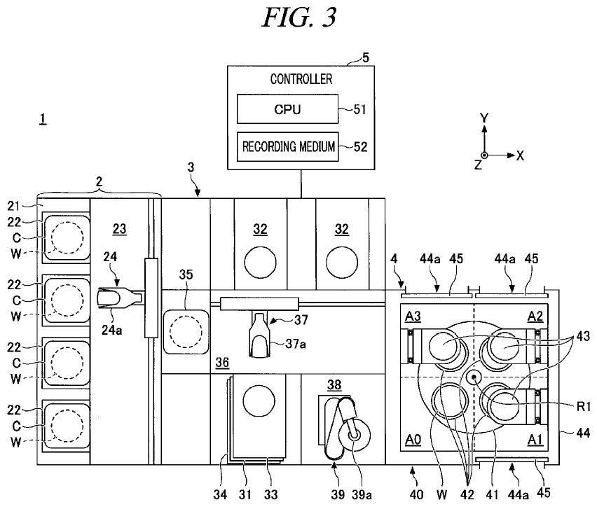

Now, referring to FIG. 3, the grinding system 1 will be described. The grinding system 1 includes a carry-in/out section 2, a cleaning section 3, a grinding section 4, and a controller 5. The carry-in/out section 2, the cleaning section 3 and the grinding section 4 are arranged in this order from the negative X-axis side to the positive X-axis side.

The carry-in/out section 2 has a placing table 21. The placing table 21 is a place where a cassette C is placed. The cassette C accommodates therein a plurality of substrates W at a regular interval therebetween in a vertical direction. The placing table 21 includes a plurality of placement plates 22 arranged in a row in the Y-axis direction. The cassette C is disposed on each of the plurality of placement plates 22. Here, the number of the placement plates 22 is not particularly limited. Likewise, the number of the cassettes C is not particularly limited, either.

Further, the carry-in/out section 2 has a first transfer region 23. When viewed from the top, the first transfer region 23 is provided next to a transition device 35 to be described later and the placing table 21 so as to be interposed between the placing table 21 and the transition device 35. The carry-in/out section 2 has a first transfer device 24 configured to transfer the substrate W in the first transfer region 23. The first transfer device 24 transfers the substrate W between a multiplicity of apparatuses disposed next to the first transfer region 23. The first transfer device 24 includes a first transfer arm 24a configured to hold the substrate W. The first transfer arm 24a is movable in horizontal directions (both in the X-axis direction and the Y-axis direction) and in a vertical direction, and pivotable around a vertical axis. The number of the first transfer arm 24a may be one or more.

The cleaning section 3 has a first cleaning apparatus 31. The first cleaning apparatus 31 scrub-cleans the substrate W after being ground by a grinding apparatus 40 to be described later. The first cleaning apparatus 31 includes a cleaning body such as a sponge or a brush, and removes particles such as grinding debris with the cleaning body.

In addition, the cleaning section 3 has a second cleaning apparatus 32. The second cleaning apparatus 32 etches the substrate W after being ground by the grinding apparatus 40 with a chemical liquid. The second cleaning apparatus 32 includes a spin chuck configured to hold the substrate W; and a nozzle configured to discharge the chemical liquid. The nozzle supplies the chemical liquid to the center of a top surface of the substrate W being rotated.

The cleaning section 3 may also have a third cleaning apparatus 33. Unlike the first cleaning apparatus 31 and the second cleaning apparatus 32, the third cleaning apparatus 33 cleans the substrate W before being ground by the grinding apparatus 40. The third cleaning apparatus 33 scrub-cleans the substrate W, the same as the first cleaning apparatus 31. Thus, a foreign substance can be suppressed from being mixed in between a chuck 42 of the grinding apparatus 40 and the substrate W, so that the substrate W can be ground flat.

The cleaning section 3 is equipped with a detecting apparatus 34. The detecting apparatus 34 detects the center of the substrate W before being ground by the grinding apparatus 40. When viewed from the top, the center of the chuck 42 of the grinding apparatus 40 and the center of the substrate W may be aligned. The detecting apparatus 34 may detect the crystal orientation of the substrate W in addition to the center of the substrate W. Specifically, it may detect a notch or an orientation flat indicating the crystal orientation of the substrate W. On a rotational coordinate system that is rotated along with the chuck 42, the crystal orientation of the substrate W can be aligned to a required direction.

The first cleaning apparatus 31, the third cleaning apparatus 33, and the detecting apparatus 34 may be vertically stacked in order to reduce the installation area of the grinding system 1. For example, the detecting apparatus 34, the first cleaning apparatus 31, and the third cleaning apparatus 33 are arranged in this order from bottom to top. Here, however, the order is not specifically limited.

The cleaning section 3 has the transition device 35. The transition device 35 temporarily accommodates the substrate W therein. A plurality of transition devices 35 may be stacked vertically. The layout and the number of the transition devices 35 are not particularly limited.

The cleaning section 3 has a second transfer region 36. When viewed from the top, the second transfer region 36 is disposed next to the first cleaning apparatus 31, the second cleaning apparatus 32 and the transition device 35 so that three sides of the second transfer region 36 are surrounded by the first cleaning apparatus 31, the second cleaning apparatus 32, and the transition device 35. The cleaning section 3 is equipped with a second transfer device 37 configured to transfer the substrate Win the second transfer region 36. The second transfer device 37 transfers the substrate W between the multiplicity of apparatuses located next to the second transfer region 36. The second transfer device 37 includes a second transfer arm 37a configured to hold the substrate W. The second transfer arm 37a is movable in horizontal directions (both the X-axis direction and the Y-axis direction) and a vertical direction, and pivotable around a vertical axis. The number of the second transfer arm 37a may be one or more.

The cleaning section 3 has a shape in which a corner of a rectangle is cut out, when viewed from the top, and a third transfer region 38 is provided in this cut-out portion. When viewed from the top, the third transfer region 38 is disposed next to the second transfer region 36, the first cleaning apparatus 31 and the grinding apparatus 40 so that three sides of the third transfer region 38 are surrounded by the second transfer region 36, the first cleaning apparatus 31, and the grinding apparatus 40. The third transfer region 38 may be provided inside a housing that encloses both the cleaning section 3 and the third transfer region 38, or may be provided inside a housing different from the housing enclosing the cleaning section 3 and be connected to the cleaning section 3.

The grinding system 1 is equipped with a third transfer device 39 configured to transfer the substrate W in the third transfer region 38. The third transfer device 39 transfers the substrate W between the plurality of apparatuses disposed next to the third transfer region 38. The third transfer device 39 has an attraction pad 39a configured to hold the substrate W. The attraction pad 39a attracts the substrate W from above. The attraction pad 39a is movable in horizontal directions (both the X-axis direction and the Y-axis direction) and a vertical direction, and pivotable around a vertical axis.

The grinding section 4 includes the grinding apparatus 40. The grinding apparatus 40 is configured to grind the substrate W. The grinding includes polishing. Either fixed abrasive grains or free abrasive grains may be used as abrasive grains for use in the grinding. The grinding apparatus 40 includes, by way of example, a table 41, four chucks 42, and three processing mechanisms 43.

The table 41 holds the four chucks 42 around a rotation center line R1 at a regular distance therebetween, and is rotated about the rotation center line R1. Each of the four chucks 42 is rotated together with the table 41 and moved to a carry-in/out position A0, a first grinding position A1, a second grinding position A2, a third grinding position A3, and back to the carry-in/out position A0.

The carry-in/out position A0 serves as a carry-in position where a carry-in of the substrate W is performed and a carry-out position where a carry-out of the substrate W is performed. Although the carry-in position and the carry-out position are identical in the present exemplary embodiment, they may be different. The first grinding position A1 is a position where first grinding of the substrate W is performed. The second grinding position A2 is a position where second grinding of the substrate W is performed. The third grinding position A3 is a position where third grinding of the substrate W is performed.

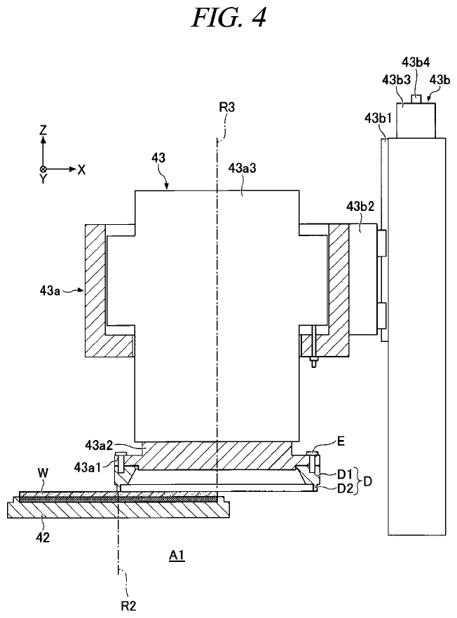

The four chucks 42 are mounted to the table 41 so as to be rotatable about their own rotation center lines R2 (see FIG. 4). At the first grinding position A1, the second grinding position A2 and the third grinding position A3, the chucks 42 are rotated about their own rotation center lines R2.

One of the processing mechanisms 43 performs the first grinding of the substrate W at the first grinding position A1. Another processing mechanism 43 performs the second grinding of the substrate W at the second grinding position A2. The other processing mechanism 43 performs the third grinding of the substrate W at the third grinding position A3.

In addition, the number of the processing mechanisms 43 may be one or more. Further, the number of the chucks 42 needs to be larger than the number of the processing mechanisms 43. Here, however, the table 41 is optional. When there is no table 41, the number of the chucks 42 may be equal to the number of the processing mechanisms 43, or may be only one.

The controller 5 is, for example, a computer, and includes a CPU (Central Processing Unit) 51 and a recording medium 52 such as a memory. The recording medium 52 stores therein a program for controlling various processings performed in the grinding system 1. The controller 5 controls an operation of the grinding system 1 by causing the CPU 51 to execute the program stored in the recording medium 52.

Now, the operation of the grinding system 1 will be explained. The following operations are performed under the control of the controller 5.

First, the first transfer device 24 takes out the substrate W from the cassette C, and transfers it to the transition device 35. Then, the second transfer device 37 transfers the substrate W from the transition device 35 to the third cleaning apparatus 33.

Then, the third cleaning apparatus 33 cleans substrate W before being ground by the grinding apparatus 40. Since the clean substrate W can be placed on the chuck 42 of the grinding apparatus 40, particles can be suppressed from being mixed in. Therefore, the substrate W can be ground flat, so that deterioration of thickness discrepancy of the substrate W can be suppressed. After the substrate W is dried, the second transfer device 37 transfers the substrate W from the third cleaning apparatus 33 to the detecting apparatus 34.

Here, if the substrate W before being ground is clean, or if the grinding apparatus 40 has a device for cleaning the substrate W before being ground, the third cleaning apparatus 33 may be omitted. In such a case, the second transfer device 37 transfers the substrate W from the transition device 35 to the detecting apparatus 34.

Subsequently, the detecting apparatus 34 detects the center of the substrate W. The detecting apparatus 34 may also detect the crystal orientation of the substrate W, specifically, a notch or the like. Thereafter, the third transfer device 39 transfers the substrate W from the detecting apparatus 34 to the chuck 42 of the grinding apparatus 40. In the meantime, the controller 5 controls the third transfer device 49 based on a detection result of the detecting apparatus 34, and aligns the center of the chuck 42 with the center of the substrate W. Further, the controller 5 controls the third transfer device 39 based on the detection result of the detecting apparatus 34, and aligns the crystal orientation of the substrate W to a required direction on the rotational coordinate system that is rotated along with the chuck 42.

Thereafter, the grinding apparatus 40 grinds the top surface of the substrate W. The substrate W is rotated along with the table 41 and moved to the carry-in/out position A0, the first grinding position A1, the second grinding position A2, the third grinding position A3, and back to the carry-in/out position A0 in this order. In the meantime, the first grinding, the second grinding, and the third grinding are performed. Thereafter, the third transfer device 39 transfers the substrate W from the chuck 42 to the first cleaning apparatus 31.

Then, the first cleaning apparatus 31 cleans the top surface of the substrate W to remove particles such as grinding debris. After the substrate W is dried, the second transfer device 37 transfers the substrate W from the first cleaning apparatus 31 to the second cleaning apparatus 32.

Subsequently, the second cleaning apparatus 32 etches the top surface of the substrate W to remove a grinding mark. After the substrate W is dried, the second transfer device 37 transfers the substrate W from the second cleaning apparatus 32 to the transition device 35. Then, the first transfer device 24 transfers the substrate W from the transition device 35 to the cassette C. The substrate W is accommodated in the cassette C.

Now, with reference to FIG. 4, the processing mechanism 43 of the grinding apparatus 40 will be explained. The processing mechanism 43 has a movable unit 43a to which the grinding tool D is mounted. The processing mechanism 43 is a driving mechanism configured to drive the grinding tool D. The grinding tool D is brought into contact with the substrate W and grinds the substrate W. The grinding tool D has, for example, a disk-shaped grinding wheel D1 and a plurality of whetstones D2 arranged in a ring shape on a bottom surface of the grinding wheel D1.

The movable unit 43a includes a flange 43a1 to which the grinding tool D is mounted, a spindle shaft 43a2 having the flange 43a1 at a lower end thereof, and a spindle motor 43a3 configured to rotate the spindle shaft 43a2. The flange 43a1 is disposed horizontally, and the grinding tool D is mounted to a bottom surface thereof in a replaceable manner with a fastener E such as a bolt. The fastener E is plural in number, and these fasteners E are arranged at a regular distance therebetween along the periphery of the flange 43a1. The spindle shaft 43a2 is vertically disposed. The spindle motor 43a3 is configured to rotate the spindle shaft 43a2, thus allowing the grinding tool D mounted to the flange 43a1 to be rotated. A rotation center line R3 of the grinding tool D coincides with a rotation center line of the spindle shaft 43a2.

The processing mechanism 43 further includes an elevating unit 43b configured to move the movable unit 43a up and down. The elevating unit 43b includes, for example, a vertical Z-axis guide 43b1, a Z-axis slider 43b2 configured to be moved along the Z-axis guide 43b1, and a Z-axis motor 43b3 configured to move the Z-axis slider 43b2. The movable unit 43a is fixed to the Z-axis slider 43b2, and the movable unit 43a and the grinding tool D are moved up and down along with the Z-axis slider 43b2. The elevating unit 43b is further equipped with a position detector 43b4 configured to detect the position of the grinding tool D. For example, the position detector 43b4 detects, for example, the rotation of the Z-axis motor 43b3 to detect the position of the grinding tool D.

The elevating unit 43b lowers the grinding tool D from a standby position. The grinding tool D is rotated while being lowered, brought into contact with the top surface of the substrate W being rotated, and grinds the entire top surface of the substrate W. If the thickness of the substrate W reaches a set value, the elevating unit 43b stops the descent of the grinding tool D. Thereafter, the elevating unit 43b raises the grinding tool D up to the standby position.

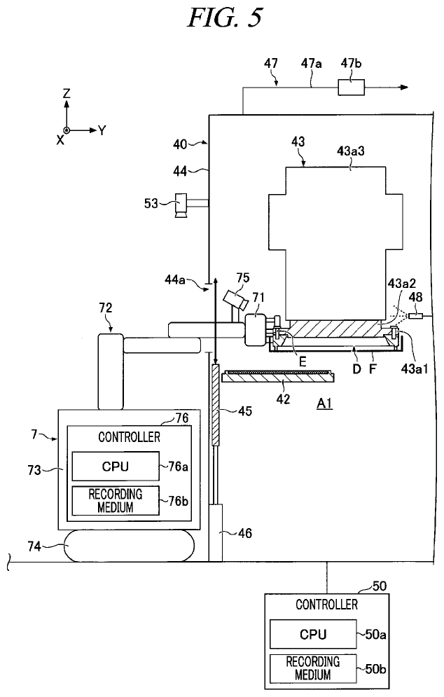

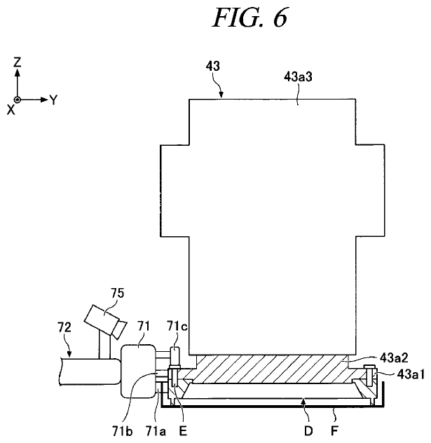

Now, referring to FIG. 5 and FIG. 6, installation and separation of the grinding tool D to/from the processing mechanism 43 will be described. As shown in FIG. 5, the grinding apparatus 40 includes an exterior cover 44. The exterior cover 44 accommodates the chuck 42 as a holder configured to hold the substrate W and the processing mechanism 43 to which the grinding tool D is installed in a replaceable manner. The exterior cover 44 suppresses particles such as grinding debris generated therein from being flown out. Thus, the factory room can be maintained clean.

The exterior cover 44 has an entrance opening 44a through which the replacing apparatus 7 advances into the exterior cover 44 from the outside thereof. Instead of a person, the replacing apparatus 7 advances into the exterior cover 44 from the outside thereof, and replaces the grinding tool D within the exterior cover 44.

Since the replacing apparatus 7 enters the exterior cover 44 instead of a person to replace the grinding tool D, it is possible to suppress the person from getting dirty with deposits within the exterior cover 44. Further, since the replacing apparatus 7 is provided outside the grinding apparatus 40, the grinding apparatus 40 can be scaled down, as compared to a case where the replacing apparatus 7 is provided inside the grinding apparatus 40.

The grinding apparatus 40 is provided with a shutter 45 configured to open or close the entrance opening 44a of the exterior cover 44. The shutter 45 basically keeps the entrance opening 44a closed, and opens the entrance opening 44a when the replacing apparatus 7 enters. As compared to a case where the entrance opening 44a is always open, it is possible to suppress an outflow of particles from the inside of the exterior cover 44 to the outside thereof through the entrance opening 44a, so that the factory room can be kept clean.

The grinding apparatus 40 may be equipped with a moving mechanism 46 configured to move the shutter 45 between an opening position (for example, the position shown in FIG. 5) where it opens the entrance opening 44a and a closing position where it closes the entrance opening 44a. The moving mechanism 46 is a pneumatic cylinder, an electric cylinder, or the like. The electric cylinder includes a motor and a ball screw. The shutter 45 can be moved automatically, not manually.

As illustrated in FIG. 3, the grinding apparatus 40 is provided with the plurality of processing mechanisms 43, and the entrance opening 44a is provided for each of the processing mechanisms 43 individually. For example, the processing mechanism 43 and the entrance opening 44a are provided at each of the first grinding position A1, the second grinding position A2 and the third grinding position A3. The shutter 45 is provided for each entrance opening 44a, and the shutter 45 is moved for each entrance opening 44a.

The effect of providing the replacing apparatus 7 outside the grinding apparatus 40 becomes conspicuous with an increase of the number of the processing mechanisms 43. Unlike in the present exemplary embodiment, if the replacing apparatus 7 is provided inside the grinding apparatus 40 for each processing mechanism 43 individually, or if the replacing apparatus 7 shared by the plurality of processing mechanisms 43 is provided inside the grinding apparatus 40, the grinding apparatus 40 is scaled up. According to the present exemplary embodiment, on the other hand, since the replacing apparatus 7 is provided outside the grinding apparatus 40, the size of the grinding apparatus 40 can be reduced. Here, however, it is also possible that only one processing mechanism 43 is provided.

As illustrated in FIG. 5, the grinding apparatus 40 may be equipped with a restricting mechanism 47. The restricting mechanism 47 is configured to restrict an outflow of a gas from the inside of the exterior cover 44 to the outside through the entrance opening 44a of the exterior cover 44. By restricting the outflow of the gas, an outflow of particles can be suppressed, so that the factory room can be kept clean.

By way of example, the restricting mechanism 47 is equipped with an exhaust line 47a through which the inside of the exterior cover 44 is set to a negative pressure, as compared to the outside thereof. The exhaust line 47a is a duct or the like, and connects the exterior cover 44 to an exhaust source. The exhaust source is, for example, a vacuum pump or an ejector. A pressure controller 47b, for example, is provided at a portion of the exhaust line 47a. The pressure controller 47b is configured to control a pressure within the exterior cover 44. Due to a pressure difference between the inside and the outside of the exterior cover 44, an airflow heading toward the inside of the exterior cover 44 from the entrance opening 44a of the exterior cover 44 is formed. As a result, the outflow of the gas from the inside of the exterior cover 44 to the outside thereof can be restricted.

Although a connection opening through which the exhaust line 47a is connected to the exterior cover 44 is located above the entrance opening 44a of the exterior cover 44 in FIG. 5, it may be provided below the entrance opening 44a. In this case, a downflow may be formed inside the exterior cover 44. A blower such as a fan filter unit may be provided at a ceiling of the exterior cover 44. A blowing amount and an exhaust amount are controlled such that the inside of the exterior cover 44 has a negative pressure as compared to the outside thereof.

The grinding apparatus 40 may be equipped with a washing mechanism 48. The washing mechanism 48 supplies a cleaning liquid to the grinding tool D or a member around the grinding tool D by a nozzle or the like. The cleaning liquid is, for example, DIW (deionized water) or the like. The member around the grinding tool D is, for example, the flange 43a1 or the spindle shaft 43a2. Before removing the used grinding tool D from the processing mechanism 43, the grinding tool D and the like are washed. Thus, the replacing apparatus 7 can be suppressed from becoming dirty. In addition, if the grinding tool D is cleaned by the washing mechanism 48, it is possible to suppress the particles from being moved out together with the grinding tool D.

The grinding apparatus 40 includes a controller 50. The controller 50 is, for example, a computer, and includes a CPU 50a and a recording medium 50b such as a memory. The recording medium 50b stores therein a program for controlling various processings performed in the grinding apparatus 40. The controller 50 controls the operation of the grinding apparatus 40 by causing the CPU 50a to execute the program stored in the recording medium 50b. The controller 50 of the grinding apparatus 40 may be a part of the controller 5 of the grinding system 1.

The replacing apparatus 7 includes, for example, a replacing mechanism 71, a moving mechanism 72, the traveling table 73, and a traveling mechanism 74. The replacing mechanism 71 is configured to install the grinding tool D to the processing mechanism 43, or separate the grinding tool D from the processing mechanism 43. The replacing mechanism 71 is configured to be movable in horizontal directions (both in the X-axis direction and the Y-axis direction) and in a vertical direction, and pivotable about a vertical axis. The moving mechanism 72 is configured to move the replacing mechanism 71 from the outside of the exterior cover 44 to the inside thereof through the entrance opening 44a of the exterior cover 44. The moving mechanism 72 is, for example, a multi-joint arm, which holds the replacing mechanism 71 at one end thereof and is connected to the traveling table 73 at the other end thereof. The traveling table 73 supports the moving mechanism 72. The traveling mechanism 74 is configured to cause the traveling table 73 to travel.

Since the replacing apparatus 7 is provided outside the grinding apparatus 40, the self-propelled robot is used as the replacing apparatus 7, unlike a case where the replacing apparatus 7 is provided inside the grinding apparatus 40. Instead of a person, the replacing apparatus 7 replaces the grinding tool D. Therefore, it is possible to suppress the people from getting dirty. In addition, since the replacing apparatus 7 is provided outside the grinding apparatus 40, the size of the grinding apparatus 40 can be reduced, as compared to the case where the replacing apparatus 7 is provided inside the grinding apparatus 40.

As shown in FIG. 6, the replacing mechanism 71 has a holding mechanism 71a configured to hold the grinding tool D. The holding mechanism 71a holds a container F for accommodating therein the grinding tool D. The container F is of a box shape with an open top, and has a recessed portion in a top surface thereof. The grinding tool D is accommodated in this recessed portion. The container F accommodates therein the grinding tool D, and suppresses a grinding liquid, grinding debris, and the like from falling down when the grinding tool D is separated. Further, the holding mechanism 71a may be configured to hold the grinding tool D itself.

The replacing mechanism 71 has a rotation stopping mechanism 71b configured to stop the rotation of the spindle shaft 43a2 of the processing mechanism 43. The rotation stopping mechanism 71b includes, for example, a clamp configured to hold the flange 43a1 or the spindle shaft 43a2. Alternatively, the rotation stopping mechanism 71b includes a pin to be inserted into a hole of the flange 43a1 or the spindle shaft 43a2. In the state that the rotation of the spindle shaft 43a2 is stopped by the rotation stopping mechanism 71b and the rotation of the grinding tool D is thus stopped, the fastener E may be tightened or loosened.

The replacing mechanism 71 has a manipulating mechanism 71c configured to tighten or loosen the fastener E configured to fasten the grinding tool D and the processing mechanism 43. When the fastener E is a bolt, the manipulating mechanism 71c is composed of a tool such as a spanner or a wrench to be engaged with the bolt and a rotating mechanism configured to rotate the tool.

As shown in FIG. 1, etc., the set of the replacing mechanism 71 and the moving mechanism 72 may be provided in plurality and controlled independently. One set is used for the installation of the grinding tool D, and another set is used for the separation of the grinding tool D. If the set of the replacing mechanism 71 and the moving mechanism 72 is plural in number, the separation and the installation of the grinding tool D can be promptly performed in succession, unlike a case where only one set is provided. That is, the replacing apparatus 7 does not need to be moved back and forth between the grinding apparatus 40 and the storage 9 between the separation and the installation of the grinding tool D.

In addition, if the storage 9 (see FIG. 11) of the replacing apparatus 7 stores both the used grinding tool D and the unused grinding tool D, the installation and the separation of the grinding tools D can be carried out promptly in succession even though only one replacing mechanism 71 and moving mechanism 72 are provided. Further, if the storage 9 (see FIG. 11) of the replacing apparatus 7 stores both a plurality of used grinding tools D and a plurality of unused grinding tools D, the replacing apparatus 7 can carry out the replacing operation for the plurality of processing mechanisms 43 successively without being moved back and forth between the storage 9 (see FIG. 1 and FIG. 2) provided outside it and the grinding apparatus 40.

The replacing apparatus 7 may be equipped with an imaging device 75 configured to image the replacing mechanism 71. The imaging device 75 is mounted to the one end of the moving mechanism 72, the same as the replacing mechanism 71. Thus, it is possible to control the replacing mechanism 71 while monitoring the operation of the replacing mechanism 71 with the imaging device 75.

The replacing apparatus 7 is equipped with a controller 76. The controller 76 is, for example, a computer, and includes a CPU 76a and a recording medium 76b such as a memory. The recording medium 76b stores therein a program for controlling various processings performed in the replacing apparatus 7. The controller 76 controls the operation of the replacing apparatus 7 by causing the CPU 76a to execute the program stored in the recording medium 76b.

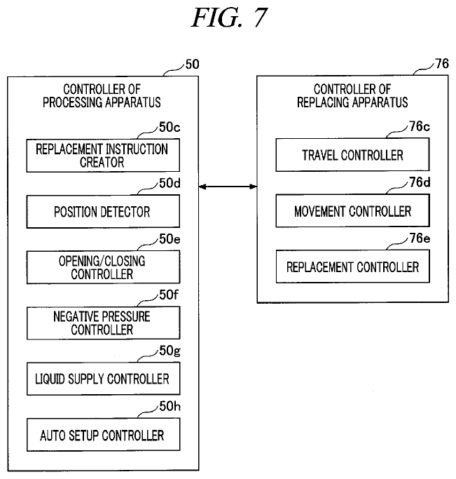

Now, referring to FIG. 7, the function of the controller 50 of the grinding apparatus 40 and the function of the controller 76 of the replacing apparatus 7 will be explained. Further, individual functional blocks shown in FIG. 7 are conceptual and may not necessarily be physically configured exactly the same as shown in FIG. 7. All or a part of the functional blocks may be functionally or physically dispersed or combined on a unit. All or a part of processing functions performed in the respective functional blocks may be implemented by a program executed by the CPU or implemented by hardware through a wired logic.

First, the function of the controller 50 of the grinding apparatus 40 will be described. The controller 50 includes, by way of example, a replacement instruction creator 50c, a position detector 50d, an opening/closing controller 50e, a negative pressure controller 50f, a cleaning controller 50g, and an auto setup controller 50h.

The replacement instruction creator 50c is configured to determine whether the replacement of the grinding tool D is necessary, and create a replacement instruction for the grinding tool D. Specifically, the replacement instruction creator 50c monitors, for example, the number of substrates W ground by the grinding tool D, the wear amount of the grinding tool D, or the elapsed time after the grinding tool D is installed. When the monitored value reaches a set value, the replacement instruction creator 50c creates the replacement instruction. The created replacement instruction is transmitted to the controller 76 of the replacing apparatus 7 in a wireless or wired manner. The replacing apparatus 7 and the grinding apparatus 40 may transmit/receive signals via an external computer. The replacing apparatus 7 is moved to the grinding apparatus 40 in response to the replacement instruction, that is, a request from the grinding apparatus 40.

The position detector 50d is configured to detect, with a sensor 53, whether or not the traveling table 73 of the replacing apparatus 7 has arrived at a position (for example, the position shown in FIG. 5) at which the grinding tool D is to be replaced. The position where the grinding tool D is to be replaced is set outside the exterior cover 44, and serves as both a position where the grinding tool D is installed and a position where the grinding tool D is separated. The sensor 53 is configured to detect, for example, the arrival of the traveling table 73 of the replacing apparatus 7 at the set position outside the exterior cover 44. The sensor 53 is mounted to, for example, an outer wall surface of the exterior cover 44 to be located above the entrance opening 44a. The sensor 53 is, for example, a camera or the like.

The opening/closing controller 50e is configured to control the moving mechanism 46 of the shutter 45 and control the position of the shutter 45. If the traveling table 73 of the replacing apparatus 7 arrives at the position where the grinding tool D is to be replaced, the opening/closing controller 50e changes the position of the shutter 45 from the closing position to the opening position. Further, if the traveling table 73 of the replacing apparatus 7 is retreated from the position at which the grinding tool D is replaced, the opening/closing controller 50e changes the position of the shutter 45 from the opening position to the closing position.

The negative pressure controller 50f is configured to control the pressure controller 47b of the exhaust line 47a to turn the inside of the exterior cover 44 into a negative pressure as compared to the outside. The negative pressure controller 50f sets the inside of the exterior cover 44 to be the negative pressure as compared to the outside of the exterior cover 44, at least while the shutter 45 maintains the entrance opening 44a of the exterior cover 44 opened.

The cleaning controller 50g is configured to control the washing mechanism 48 to supply the cleaning liquid to the grinding tool D or the member around the grinding tool D before the shutter 45 opens the entrance opening 44a of the exterior cover 44. The supply of the cleaning liquid may be performed after the replacement instruction for the grinding tool D is created, for example. In addition, the supply of the cleaning liquid may also be performed during the grinding or at the end of the grinding of the substrate W.

The auto setup controller 50h is configured to perform an auto setup when the replacement of the grinding tool D is completed and the replacing apparatus 7 is retreated from the position at which the grinding tool D is replaced. The auto setup includes, for example, dressing of the unused grinding tool D, or temperature adjustment of the inside of the exterior cover 44.

Now, the function of the controller 76 of the replacing apparatus 7 will be discussed. The controller 76 includes, for example, a travel controller 76c, a movement controller 76d, and a replacement controller 76e.

The travel controller 76c is configured to control the traveling mechanism 74 and control the position of the traveling table 73. For example, the travel controller 76c controls the traveling mechanism 74 to move the traveling table 73 between the position where the grinding tool D is stored and the position where the grinding tool D is to be replaced.

The movement controller 76d is configured to control the moving mechanism 72, and control the position of the replacing mechanism 71. If the replacing apparatus 7 detects, through the signal transmitted from the grinding apparatus 40, a state in which the traveling table 73 is stopped at the position where the grinding tool D is to be replaced and the entrance opening 44a of the exterior cover 44 is opened, the movement controller 76d moves the replacing mechanism 71 from the outside of the exterior cover 44 to the inside thereof through the entrance opening 44a of the exterior cover 44. Further, before the traveling table 73 is retreated from the position where the grinding tool D is to be replaced, the movement controller 76d moves the replacing mechanism 71 from the inside of the exterior cover 44 to the outside thereof through the entrance opening 44a of the exterior cover 44.

The replacement controller 76e is configured to control the replacing mechanism 71, and control the separation or installation of the grinding tool D. The replacement controller 76e causes the manipulating mechanism 71c to tighten or loosen the fastener E in the state that the grinding tool D is held by the holding mechanism 71a and the rotation of the spindle shaft 43a2 is stopped by the rotation stopping mechanism 71b. The replacement controller 76e controls the replacing mechanism 71 while monitoring the operation of the replacing mechanism 71 with the imaging device 75.

Now, the operations of the grinding apparatus 40 and the replacing apparatus 7 will be briefly explained. The grinding apparatus 40 makes the determination upon whether the replacement of the grinding tool D is necessary, and creates the replacement instruction for the grinding tool D. Then, the grinding apparatus 40 transmits the created replacement instruction to the replacing apparatus 7. Further, if it is determined that the replacement of the grinding tool D is necessary, the grinding apparatus 40 stops the grinding of the substrate W and performs the cleaning by the washing mechanism 48. Meanwhile, if the replacing apparatus 7 receives the replacement instruction from the grinding apparatus 40, it approaches the grinding apparatus 40. If the grinding apparatus 40 detects the arrival of the traveling table 73 of the replacing apparatus 7 at the position at which the grinding tool D is to be replaced, the grinding apparatus 40 opens the shutter 45. Thereafter, the replacing apparatus 7 makes the replacing mechanism 71 advance into the exterior cover 44 through the entrance opening 44a thereof. Next, the replacing apparatus 7 separates the used grinding tool D from the processing mechanism 43, and installs the unused grinding tool D to the processing mechanism 43. Thereafter, the replacing apparatus 7 retreats the replacing mechanism 71 to the outside through the entrance opening 44a of the exterior cover 44. Afterwards, the grinding apparatus 40 closes the shutter 45 and performs the auto setup control. Subsequently, the grinding apparatus 40 resumes the grinding of the substrate W.

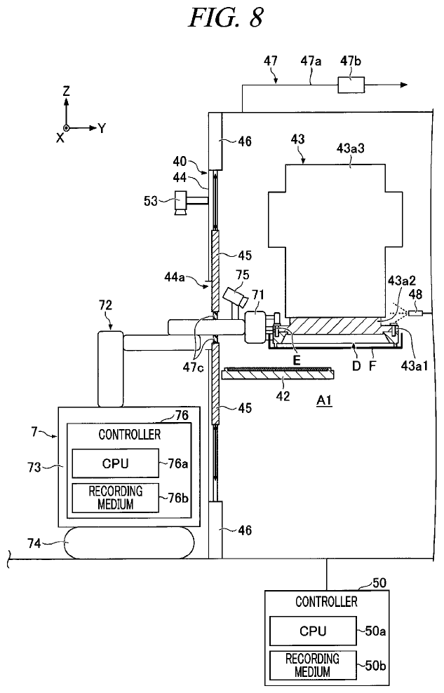

Now, referring to FIG. 8, the grinding apparatus 40 and the replacing apparatus 7 according to a first modification example will be described. Hereinafter, the description will mainly focus on differences from the above-described exemplary embodiment.

The restricting mechanism 47 of the grinding apparatus 40 according to the first modification example has a seal member 47c in addition to the exhaust line 47a. Here, it may also be possible that the restricting mechanism 47 has only the seal member 47c. The seal member 47c comes into contact with the multi-joint arm of the replacing apparatus 7 that has entered the entrance opening 44a of the exterior cover 44, thus closing the entrance opening 44a of the exterior cover 44. The seal member 47c serves to restrict the outflow of the gas, thus suppressing the outflow of the particles.

The seal member 47c is provided to, for example, the shutter 45, and is moved along with the shutter 45. The shutter 45 is provided in a pair, and the seal member 47c is attached to each of facing surfaces of the pair of shutters 45. The pair of seal members 47c surround the replacing apparatus 7 interposed therebetween, thus closing the entrance opening 44a of the exterior cover 44. The seal member 47c is formed of a flexible material such as rubber, and is transformed according to the shape of the replacing apparatus 7.

If the traveling table 73 of the replacing apparatus 7 reaches the set position outside the exterior cover 44, the opening/closing controller 50e changes the position of the shutter 45 from the closing position to the opening position. Thereafter, the movement controller 76d moves the replacing mechanism 71 from the outside of the exterior cover 44 to the inside thereof through the entrance opening 44a of the exterior cover 44. At this time, the seal member 47c is not in contact with the replacing apparatus 7.

Then, the opening/closing controller 50e changes the position of the shutter 45 from the opening position to a sealing position (for example, the position shown in FIG. 8). The sealing position is a position where the seal member 47c comes into contact with the multi-join arm of the replacing apparatus 7 or the like to close the entrance opening 44a of the exterior cover 44. With the entrance opening 44a sealed by the seal member 47c, the replacement controller 76e controls the replacing mechanism 71 to separate or install the grinding tool D.

Upon the completion of the separation or installation of the grinding tool D, the opening/closing controller 50e changes the position of the shutter 45 from the sealing position to the opening position. Subsequently, the movement controller 76d moves the replacing mechanism 71 from the outside of the exterior cover 44 to the inside thereof through the entrance opening 44a of the exterior cover 44. Thereafter, the travel controller 76c controls the traveling mechanism 74 to move the traveling table 73 from the position where the grinding tool D is replaced to the position where the grinding tool D is stored.

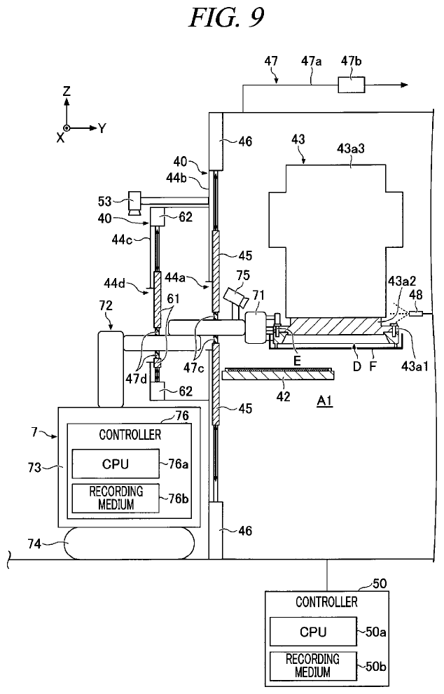

Now, referring to FIG. 9, the grinding apparatus 40 and the replacing apparatus 7 according to a second modification example will be described. Hereinafter, the description will mainly focus on differences from the above-described exemplary embodiment and first modification example.

The exterior cover 44 of the grinding apparatus 40 according to the second modification example includes a main housing 44b where the entrance opening 44a is formed, and a sub-housing 44b mounted to an outer wall surface of the main housing 44b so as to surround the entrance opening 44a of the main housing 44b. The main housing 44b accommodates therein the chuck 42 as the holder configured to hold the substrate W and the processing mechanism 43 to which the grinding tool D is installed in a replaceable manner.

The sub-housing 44c includes a second entrance opening 44d through which the replacing apparatus 7 passes when it advances into the sub-housing 44c from the outside thereof. After arriving at the position to replace the grinding tool D, the replacing apparatus 7 passes through the second entrance opening 44d and the entrance opening 44a in this order, advances into the main housing 44b, and replaces the grinding tool D within the main housing 44b.

The grinding apparatus 40 is equipped with a second shutter 61 configured to open or close the second entrance opening 44d of the sub-housing 44c. The second shutter 61 basically keeps the second entrance opening 44d closed, and opens the second entrance opening 44d when the replacing apparatus 7 enters. As compared to a case where the second entrance opening 44d is always open, it is possible to suppress the outflow of the particles from the inside of the exterior cover 44 to the outside thereof through the second entrance opening 44d, so that the factory room can be kept clean.

The grinding apparatus 40 may be further equipped with a second moving mechanism 62 configured to move the second shutter 61 between a second opening position where the shutter 61 opens the second entrance opening 44d and a second closing position where the shutter 61 closes the second entrance opening 44d. The second moving mechanism 62 is, by way of non-limiting example, a pneumatic cylinder, an electric cylinder, or the like. The second shutter 61 can be moved automatically, not manually.

Like the entrance opening 44a, the second entrance opening 44d is provided for each processing mechanism 43. For example, the second entrance opening 44d may be provided at each of the first grinding position A1, the second grinding position A2, and the third grinding position A3. The second shutter 61 is provided for each second entrance opening 44d to be moved for the corresponding second entrance opening 44d.

The controller 50 of the grinding apparatus 40 is equipped with a non-illustrated second opening/closing controller. The second opening/closing controller controls the second moving mechanism 62, and controls the position of the second shutter 61. When the traveling table 73 of the replacing apparatus 7 arrives at the position to replace the grinding tool D, the second opening/closing controller changes the position of the second shutter 61 from the second closing position to the second opening position. Further, when the traveling table 73 of the replacing apparatus 7 is retreated from the position where the grinding tool D is replaced, the second opening/closing controller changes the position of the second shutter 61 from the second opening position to the second closing position.

The restricting mechanism 47 of the grinding apparatus 40 may have a second seal member 47d. The second seal member 47d comes into contact with the multi-joint arm of the replacing apparatus 7 that has entered the second entrance opening 44d of the sub-housing 44c, thus closing the second entrance opening 44d of the sub-housing 44c. With the second seal member 47d, the outflow of the gas can be restricted, so that the outflow of the particles can be suppressed.

The second seal member 47d is provided to, for example, the second shutter 61, and is moved along with the second shutter 61. The second shutters 61 is provided in a pair, and the second seal member 47d is attached to each of facing surfaces of the pair of second shutters 61. The pair of second seal members 47d surround the replacing apparatus 7 interposed therebetween, thus closing the second entrance opening 44d of the exterior cover 44. The second seal member 47d is made of a flexible material such as rubber, and is transformed according to the shape of the replacing apparatus 7.

If the traveling table 73 of the replacing apparatus 7 reaches the set position outside the exterior cover 44, the second opening/closing controller changes the position of the second shutter 61 from the second closing position to the second opening position. Thereafter, the movement controller 76d moves the replacing mechanism 71 from the outside of the sub-housing 44c to the inside thereof through the second entrance opening 44d of the sub-housing 44c. At this time, the second seal member 47d is not in contact with the replacing apparatus 7.

Thereafter, the second opening/closing controller changes the position of the second shutter 61 from the second opening position to a second sealing position (for example, the position shown in FIG. 9). The second sealing position is a position where the second seal member 47d comes into contact with the multi-joint arm of the replacing apparatus 7 or the like to close the second entrance opening 44d of the sub-housing 44c. With the second entrance opening 44d closed by the second sealing member 47d, the opening/closing controller 50e changes the position of the shutter 45 from the closing position to the opening position. Next, the movement controller 76d moves the replacing mechanism 71 from the outside of the main housing 44b to the inside thereof through the entrance opening 44a of the main housing 44b. Subsequently, the opening/closing controller 50e changes the position of the shutter 45 from the opening position to the sealing position. Then, the replacement controller 76e controls the replacing mechanism 71 to separate or install the grinding tool D. Further, in case that the second seal member 47d is provided to the second shutter 61, the outflow of the particles can be suppressed if the second seal member 47d closes the second entrance opening 44d of the sub-housing 44c. Therefore, the seal member 47c may be omitted. If, however, the seal member 47c is also provided, the outflow of the particles can be further suppressed.

Upon the completion of the separation or installation of the grinding tool D, the opening/closing controller 50e changes the position of the shutter 45 from the sealing position to the opening position. Then, the movement controller 76d moves the replacing mechanism 71 from the inside of the main housing 44b to the outside thereof through the entrance opening 44a of the main housing 44b. Next, the opening/closing controller 50e changes the position of the shutter 45 from the opening position to the closing position. Thereafter, the second opening/closing controller changes the position of the second shutter 61 from the second sealing position to the second opening position. Subsequently, the movement controller 76d moves the replacing mechanism 71 from the inside of the sub-housing 44c to the outside thereof through the second entrance opening 44d of the sub-housing 44c. Thereafter, the travel controller 76c controls the traveling mechanism 74 to move the traveling table 73 from the position where the grinding tool D is replaced to the position where the grinding tool D is stored. In this way, by closing at least one of the entrance opening 44a and the second entrance opening 44d without opening them at the same time, it is possible to suppress the inside of the main housing 44b from being opened to the outside of the grinding apparatus 40.

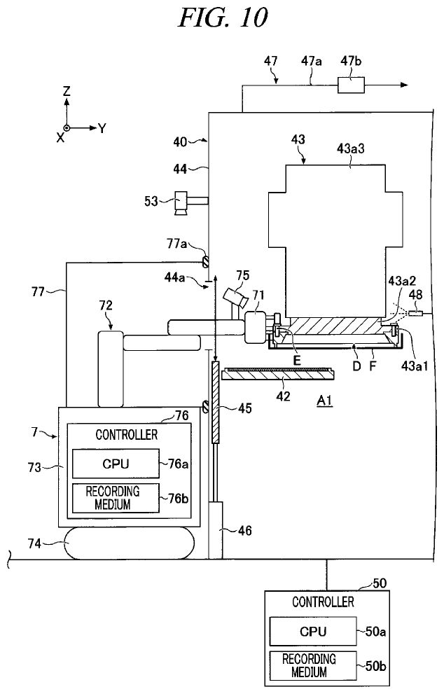

Now, referring to FIG. 10, the grinding apparatus 40 and the replacing apparatus 7 according to a third modification example will be described. Hereinafter, the description will mainly focus on the differences from the above-described exemplary embodiment, first modification example, and second modification example.

The replacing apparatus 7 of the present modification examples includes a housing 77 mounted to the traveling table 73. The housing 77 is configured to come into contact with the outer wall surface of the exterior cover 44 in the state the replacing mechanism 71 and the moving mechanism 72 are accommodated therein, thus sealing the inside of the housing 77. The housing 77 may have a seal member 77a on a surface thereof in contact with the exterior cover 44.

If the shutter 45 opens the entrance opening 44a of the exterior cover 44, the inside of the housing 77 communicates with the inside of the exterior cover 44 through the entrance opening 44a of the exterior cover 44. In this state, the replacement of the grinding tool D is performed. With this housing 77, the outflow of the gas can be restricted and the outflow of the particles can thus be suppressed. Therefore, the factory room can be kept clean.

In addition, as illustrated in FIG. 9, when the exterior cover 44 has the main housing 44b and the sub-housing 44c, the housing 77 is in contact with an outer wall surface of the sub-housing 44c. If the second shutter 61 opens the second entrance opening 44d of the sub-housing 44c and the shutter 45 opens the entrance opening 44a of the main housing 44b, the inside of the housing 77 and the inside of the main housing 44b communicate with each other.

Meanwhile, as illustrated in FIG. 6, the processing mechanism 43 includes a mounting member (for example, the flange 43a1) to which the grinding tool D is mounted in a replaceable manner; and the fastener E configured to fasten the grinding tool D and the flange 43a1. The fastener E is, for example, a bolt. The fastener E fastens the flange 43a1 and the grinding tool D from above the flange 43a1. By way of example, the fastener E is inserted through a straight hole penetrating the flange 43a1 in an up-down direction and screwed into a screw hole formed in a top surface of the grinding tool D (specifically, the grinding wheel D1). The manipulation of the fastener E is performed by the manipulating mechanism 71c. The manipulating mechanism 71c tightens or loosens the fastener E above the flange 43a1, as shown in FIG. 6.

A cover or the like covering the spindle shaft 43a2 may be provided above the flange 43a1 to protect the spindle shaft 43a2 from the grinding liquid containing grinding debris. If the cover or the like is provided, however, it would become difficult for the manipulating mechanism 71c to advance to a space above the flange 43a1, which makes the manipulation of the fastener E difficult.

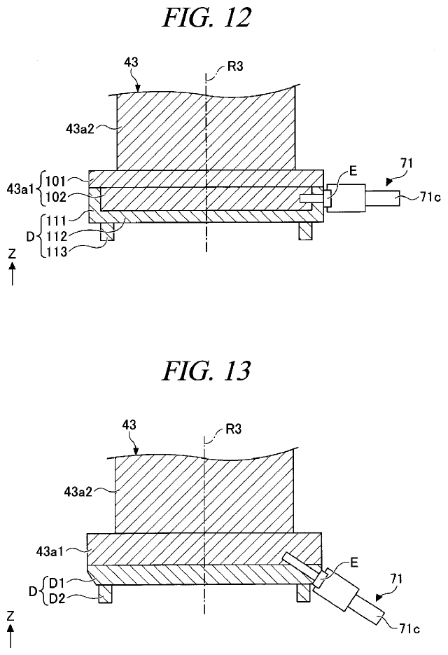

As a resolution, the fastener E may fasten the flange 43a1 and the grinding tool D from the side of the flange 43a1, as depicted in FIG. 12. Alternatively, as shown in FIG. 13, the fastener E may fasten the flange 43a1 and the grinding tool D from obliquely below the flange 43a1. In either case, the manipulating mechanism 71c does not advance to the space above the flange 43a1, so that the manipulating mechanism 71c can easily manipulate the fastener E even when the cover or the like is provided above the flange 43a1.

As shown in FIG. 12, the flange 43a1 includes, by way of example, a disk-shaped upper flange 101 and a disk-shaped lower flange 102 having an outer diameter smaller than that of the upper flange 101. Meanwhile, the grinding tool D includes a ring portion 111 in which the lower flange 102 is fitted; a disk portion 112 blocking the bottom of the ring portion 111; and a plurality of whetstones 113 arranged along the outer periphery of the disk portion 112.

As shown in FIG. 12, the axial direction of the fastener E may be orthogonal to the rotation center line R3 of the spindle shaft 43a2. For example, the fastener E is inserted into a straight hole penetrating the grinding tool D (specifically, the ring portion 111) in a diametrical direction, and is screwed into a screw hole formed in an outer peripheral surface of the flange 43a1 (specifically, the lower flange 102).

Alternatively, as illustrated in FIG. 13, the axial direction of the fastener E may be inclined downwards as it goes away from the rotation center line R3 of the spindle shaft 43a2. For example, the fastener E is inserted into a straight hole penetrating the grinding tool D obliquely, and is screwed into a screw hole formed in a bottom surface of the flange 43a1.

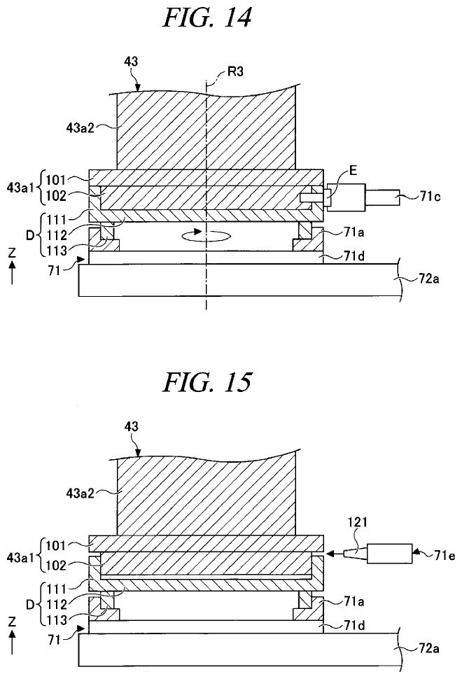

As depicted in FIG. 14, the replacing mechanism 71 has the holding mechanism 71a configured to hold the grinding tool D. The holding mechanism 71a holds the grinding tool D from below, for example. The holding mechanism 71a is provided at a leading end of the multi-joint arm 72a with a first rotating mechanism 71d to be described later therebetween, for example. The leading end of the multi-joint arm 72a advances into a space below the processing mechanism 43 sideways, and is lifted upwards. Then, the holding mechanism 71a comes into contact with the grinding tool D and holds it.

The replacing mechanism 71 may be equipped with the first rotating mechanism 71d configured to rotate the holding mechanism 71a. When the holding mechanism 71a holds the grinding tool D, a rotation center line of the holding mechanism 71a coincides with the rotation center line R3 of the spindle shaft 43a2. As the first rotating mechanism 71d rotates the holding mechanism 71a, the grinding tool D and the flange 43a1 can be rotated simultaneously, and the fastener E can be directed toward the manipulating mechanism 71c. Therefore, the operation of the manipulating mechanism 71c can be simplified.

When the plurality of fasteners E are provided at a regular distance therebetween in a circumferential direction of the grinding tool D, the controller 76 repeatedly performs the rotation of the holding mechanism 71a by the first rotating mechanism 71d and the loosening of the fasteners E by the manipulating mechanism 71c. Before the manipulating mechanism 71c loosens the fastener E, the rotation of the holding mechanism 71a is stopped so that the fastener E is directed toward the manipulating mechanism 71c. At this time, the controller 76 may monitor the position of the fastener E by using the imaging device 75 shown in FIG. 6, determine whether the position of the fastener E is a required position, and control a rotation stop position of the holding mechanism 71a. If all the fasteners E are separated, the coupling between the grinding tool D and the processing mechanism 43 is released.

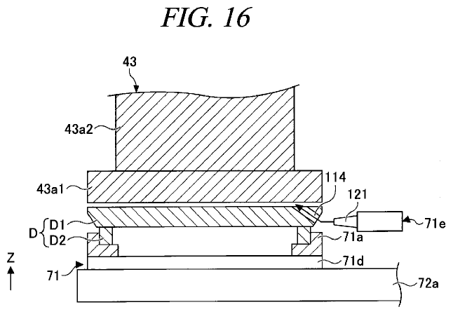

The replacing mechanism 71 may have a gas supply mechanism 71e configured to supply a gas between the grinding tool D and the processing mechanism 43, as shown in FIG. 15, in order to support the separation of the grinding tool D and the processing mechanism 43. The gas supply mechanism 71e includes a nozzle 121 configured to discharge the gas. The nozzle 121 supplies the gas into a gap between a bottom surface of the upper flange 101 and a top surface of the ring portion 111, for example. The grinding tool D and the processing mechanism 43 can be easily separated due to a wind pressure of the gas.

The grinding tool D may be provided with, as shown in FIG. 16, a hole 114 which guides the gas supplied from the nozzle 121 to a contact surface between the grinding tool D and the processing mechanism 43. The hole 114 guides the gas supplied from the nozzle 121 into a gap between the bottom surface of the flange 43a1 and the top surface of the grinding tool D, for example. The hole 114 may be a dedicated hole, or the hole (for example, the straight hole or the screw hole) for mounting the fastener E may be used as the hole 114.

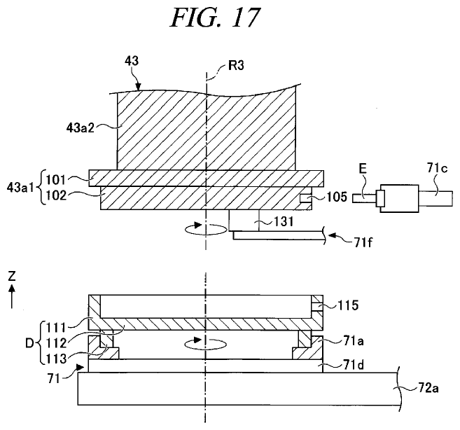

As shown in FIG. 17, the replacing mechanism 71 may include a second rotating mechanism 71f configured to rotate the spindle shaft 43a2 of the processing mechanism 43. The second rotating mechanism 71f includes, for example, a roller 131. A rotation center line of the roller 131 is parallel to the rotation center line R3 of the spindle shaft 43a2, and the roller 131 comes into contact with the flange 43a1. When the roller 131 is rotated, the flange 43a1 is also rotated by friction.

The second rotating mechanism 71f rotates the flange 43a1 before the grinding tool D is mounted to the flange 43a1, thus allowing a hole 105 of the flange 43a1, through which the fastener E is mounted, (for example, a screw hole or a straight hole) to be directed toward a required direction. At this time, the controller 76 may monitor the direction of the flange 43a1 by using the imaging device 75 shown in FIG. 6, determine whether the direction of the flange 43a1 is a required direction, and control the rotation stop position of the flange 43a1.

Moreover, as shown in FIG. 17, the first rotating mechanism 71d rotates the grinding tool D before the grinding tool D is mounted to the flange 43a1, thus allowing a hole 115 of the grinding tool D, through which the fastener E is mounted, (for example, a straight hole or a screw hole) to be directed to a required direction. At this time, the controller 76 may monitor the direction of the grinding tool D by using the imaging device 75 shown in FIG. 6, determine whether the direction of the grinding tool D is a required direction, and control a rotation stop position of the grinding tool D. Thereafter, the leading end of the multi-joint arm 72a is lifted upwards, bringing the grinding tool D into contact with the flange 43a1.

The direction of the hole 115 of the grinding tool D, through which the fastener E is mounted, coincides with the direction of the hole 105 of the flange 43a1, through which the fastener E is mounted. The direction of any one set of the holes 115 and 105 is directed toward the manipulating mechanism 71c. Thereafter, the leading end of the multi-joint arm 72a is lifted upwards, and the grinding tool D is brought into contact with the flange 43a1. Then, the manipulating mechanism 71c fastens the grinding tool D and the flange 43a1 with the fastener E. Thereafter, the controller 76 repeatedly performs the rotation of the holding mechanism 71a by the first rotating mechanism 71d and the tightening of the fastener E by the manipulating mechanism 71c. At this time, the controller 76 may monitor the positions of the holes 115 and 105 by using the imaging device 75 shown in FIG. 6 to determine whether the positions of the holes 115 and 105 are required positions, and control a rotation stop position of the holding mechanism 71a. If all the fasteners E are tightened, the fastening of the grinding tool D and the processing mechanism 43 is completed.

So far, the processing apparatus, the method of mounting the processing tool of the processing apparatus, the replacing apparatus, and the replacing method according to the exemplary embodiment of the present disclosure have been described. However, the present disclosure is not limited to the above-described exemplary embodiment. Various changes, modifications, substitutions, additions, deletions and combinations may be made within the scope of the claims, which are all incorporated within a technical scope of the present disclosure.

For example, although the processing apparatus of the present disclosure is the grinding apparatus in the above-described exemplary embodiment, it may be a machining device, a cutting device, or the like. Moreover, the grinding includes polishing. The processing apparatus is not particularly limited as long as it has the processing mechanism to which the processing tool is mounted so as to be replaceable. When the processing apparatus is a machining device, a machining tool such as an end mill is provided in the processing mechanism in a replaceable manner. Moreover, when the processing apparatus is a cutting device, a cutting tool such as a blade is mounted to the processing mechanism in a replaceable manner. The processing tool is not particularly limited as long as it comes into contact with a processing target object and processes it. If the processing tool is worn out due to the contact with the processing target object, it is replaced.

In addition, although the processing target object processed by the processing apparatus of the present exemplary embodiment is the substrate W in the above-described exemplary embodiment, the processing target object is not limited to the substrate W.

This application claims priority to Japanese Patent Application No. 2020-081377, field on May 1, 2020, which application is hereby incorporated by reference in their entirety.

### EXPLANATION OF CODES

7: Replacing apparatus
40: Grinding apparatus (processing apparatus)
42: Chuck (holder)
43: Processing mechanism
44: Exterior cover
44a: Entrance opening
71: Replacing mechanism
72: Moving mechanism
73: Traveling table
74: Traveling mechanism
D: Grinding tool (processing tool)
W: Substrate (processing target object)

We claim:

1. A replacing apparatus configured to replace a processing tool in a processing apparatus including a holder configured to hold a processing target object, a processing mechanism to which the processing tool configured to process the processing target object held by the holder is installed in a replaceable manner, and an exterior cover accommodating therein the holder and the processing mechanism, the replacing apparatus comprising:
a replacing mechanism configured to install the processing tool to the processing mechanism, or separate the processing tool from the processing mechanism;
a moving mechanism configured to move the replacing mechanism from an outside of the exterior cover to an inside thereof through an entrance opening of the exterior cover;
a traveling table supporting the moving mechanism; and
a traveling mechanism configured to allow the traveling table to travel.

2. The replacing apparatus of claim 1, further comprising:
a travel controller configured to control the traveling mechanism,
wherein the processing apparatus includes multiple processing apparatuses, and the processing tool is stored in a common storage shared by the multiple processing apparatuses, and
the travel controller controls the traveling mechanism to allow the traveling table to travel between a position where the processing tool is stored and a position where the processing tool is replaced.

3. The replacing apparatus of claim 1, further comprising:
a travel controller configured to control the traveling mechanism,
wherein the processing apparatus includes multiple processing apparatuses, and the processing tool is stored in a storage provided outside each of the multiple processing apparatuses individually, and
the travel controller controls the traveling mechanism to allow the traveling table to travel between a position where the processing tool is stored and a position where the processing tool is replaced.

4. The replacing apparatus of claim 1, further comprising:
a storage configured to store the processing tool therein,
wherein the storage is moved along with the traveling table.

5. The replacing apparatus of claim 1, further comprising:
a housing mounted to the traveling table,
wherein the housing is configured to come into contact with an outer wall surface of the exterior cover to hermetically seal an inside of the housing while accommodating the replacing mechanism and the moving mechanism therein, and
the inside of the housing communicates with the inside of the exterior cover through the entrance opening of the exterior cover.

6. The replacing apparatus of claim 1,
wherein the replacing mechanism comprises a holding mechanism configured to hold the processing tool.

7. The replacing apparatus of claim 6,
wherein the holding mechanism holds a container configured to accommodate the processing tool therein.

8. The replacing apparatus of claim 6,
wherein the replacing mechanism comprises a first rotating mechanism configured to rotate the holding mechanism.

9. The replacing apparatus of claim 1,
wherein the replacing mechanism comprises a rotation stopping mechanism configured to stop rotation of a spindle shaft of the processing mechanism.

10. The replacing apparatus of claim 1,
wherein the replacing mechanism comprises a second rotating mechanism configured to rotate a spindle shaft of the processing mechanism.

11. The replacing apparatus of claim 1,
wherein the replacing mechanism comprises a manipulating mechanism configured to tighten or loosen a fastener configured to fasten the processing tool and the processing mechanism.

12. The replacing apparatus of claim 1,
wherein the replacing mechanism comprises a gas supply mechanism configured to supply a gas into a gap between the processing tool and the processing mechanism.

13. The replacing apparatus of claim 1,
wherein multiple sets of the replacing mechanism and the moving mechanism are provided and controlled independently.

14. The replacing apparatus of claim 1, further comprising:
a controller,
wherein the controller performs:
receiving a replacement instruction created in the processing apparatus;
controlling the traveling mechanism to allow the traveling table to travel to a set position outside the exterior cover, after receiving the replacement instruction;
controlling the moving mechanism to move the replacing mechanism from the outside of the exterior cover to the inside thereof through the entrance opening of the exterior cover, when the replacing apparatus detects that the entrance opening of the exterior cover is opened; and
controlling the replacing mechanism to install the processing tool to the processing mechanism, or separate the processing tool from the processing mechanism.

15. A replacing method of replacing a processing tool in a processing apparatus including a holder configured to hold a processing target object, a processing mechanism to which the processing tool configured to process the processing target object held by the holder is installed in a replaceable manner, and an exterior cover accommodating therein the holder and the processing mechanism, the replacing method comprising:
receiving, by a replacing apparatus configured to replace the processing tool, a replacement instruction created in the processing apparatus;
allowing the replacing apparatus to travel to a set position outside the exterior cover;
detecting, by the replacing apparatus, a state in which an entrance opening of the exterior cover is opened;
allowing the replacing apparatus to advance to an inside of the exterior cover from an outside thereof through the entrance opening of the exterior cover; and
installing, by the replacing apparatus, the processing tool to the processing mechanism, or separating the processing tool from the processing mechanism.
